(19) United States
(12) Patent Application Publication
(10) Pub. No.: US 2023/0391313 A1
(43) Pub. Date: Dec. 7, 2023

(54) CONTROL FOR A COMBUSTION ENGINE IN A SERIES HYBRID OR RANGE EXTENDER ARCHITECHTURE

(71) Applicant: Cummins Inc., Columbus, IN (US)

(72) Inventors: Dat Duc Le, Columbus, IN (US); Carlos Alcides Lana, Columbus, IN (US); Kenneth M. Follen, Columbus, IN (US)

(21) Appl. No.: 17/834,193

(22) Filed: Jun. 7, 2022

(51) Int. Cl. B60W 20/16; B60W 10/06; B60W 10/08; F02D 41/02; B60W 10/26

(52) U.S. Cl. CPC B60W 20/16; B60W 10/06; B60W 10/08; F02D 41/024; B60W 10/26; B60W 2510/244; F02D 2200/0802

(57) ABSTRACT

A series or range extender hybrid vehicle drive system is disclosed having a combustion engine with an exhaust aftertreatment device, a motor/generator, an electrical energy storage and a traction motor. The traction motor is driven using power from the energy storage and/or the engine. A controller of the system is operable to receive input data representative of a requested power from the drive system, a state of charge indication of the electrical energy storage and at least one of the oxygen level in exhaust gas from the engine and temperature in the exhaust gas. The controller is also operable to provide output signals to control torque and speed of the engine and motor/generator to minimize exhaust emissions output and any tracking error of the state of charge of the energy storage to a desired target.

### GOVERNMENT SUPPORT

This invention was made with Government support under DE-ACO2-06CH11357 awarded by Department of Energy (DOE). The Government has certain rights in this invention.

### FIELD

Present disclosure generally relates to control strategies, systems and apparatus, and more particularly for series hybrid or range extender powertrain configurations for vehicles.

### BACKGROUND

For a series (or range extender) hybrid architecture, the engine is decoupled from traction machine. Therefore, there are good opportunities to operate the engine with high level of independence from any traction power request to provide improved fuel economy, emissions, and/or component life. With more stringent regulation on CO₂, low-carbon fuel engines, such as natural gas engines, are becoming increasingly important. This disclosure provides a number of features for any types of combustion engines and some specific features applicable for spark-ignited engines e.g. natural gas, propane, gasoline engines.

### SUMMARY

In some embodiments as disclosed herein, a series or range extender hybrid vehicle drive system is provided having a combustion engine with an exhaust aftertreatment device, a motor/generator, an electrical energy storage and a traction motor, wherein the traction motor is mechanically couplable to the driven wheels of a vehicle, the motor/generator is mechanically coupled to the combustion engine, is electrically coupled to the energy storage and is operable to generate electrical energy when driven by the combustion engine, and wherein the system is operable to drive the traction motor using power from the energy storage, power from the engine, or a combination of power from the engine and the energy storage, the system further having a controller which is operable to receive input data representative of a requested power from the drive system, a state of charge indication of the electrical energy storage and at least one of the oxygen level in exhaust gas from the engine and temperature in the exhaust gas and which is also operable to provide output signals to control torque and speed of the engine and motor/generator to minimize exhaust emissions output and any tracking error of the state of charge of the energy storage to a desired target.

In a first aspect, a series or range extender hybrid vehicle drive system is provided having a combustion engine with an exhaust aftertreatment device, a motor/generator, an electrical energy storage and one or more traction motors, wherein the traction motor is mechanically couplable to the driven wheels of a vehicle and also to the energy storage, the motor/generator is coupled to the combustion engine mechanically, is electrically coupled to the energy storage and is operable to generate electrical energy when driven by the combustion engine or provide mechanical energy to the combustion engine when the combustion engine is an energy dissipation device such as during engine braking, and wherein the system is operable to drive the traction motor using power from the energy storage, power from the engine, or a combination of power from the engine and the energy storage, the system further having a controller which takes, input data representative of a requested torque or power output from the drive system, the state of charge (SOC) of the energy storage, the battery power limits of the energy storage, the temperature of the exhaust aftertreatment system and the oxygen level in exhaust gases, typically pre, mid, and/or post the exhaust aftertreatment system and is operable to control the engine torque delivery and the traction motor torque delivery, to achieve an optimized exhaust emissions output and to meet the requested torque or power output.

In a second aspect, a controller is provided for a series or range extender hybrid vehicle having a combustion engine with an exhaust aftertreatment device, a motor/generator, an electrical energy storage and one or more traction motors, wherein the traction motor is mechanically couplable to the driven wheels of a vehicle and also to the energy storage, the motor/generator is coupled to the combustion engine mechanically, is electrically coupled to the energy storage and is operable to generate electrical energy when driven by the combustion engine or provide mechanical energy to the combustion engine when the combustion engine is an energy dissipation device such as during engine braking, and wherein the system is operable to drive the traction motor using power from the energy storage, power from the engine, or a combination of power from the engine, and the energy storage, wherein the controller takes input data representative of a requested torque or power output from the drive system, the state of charge of the energy storage, the temperature of the exhaust aftertreatment system and the oxygen level in exhaust gases typically, pre, mid, and/or post the exhaust aftertreatment system and is operable to control the engine torque delivery and the traction motor torque delivery, to achieve an optimized exhaust emissions output and to meet the requested torque or power output.

Some embodiments as disclosed herein also include computer program product aspects, which when implemented/executed on suitable hardware would carry out the functional steps of the controller.

With this arrangement, the controller is able to adjust the operating parameters of the engine to maximize the fuel economy or emissions characteristics in that operating state, whilst using the traction motor and energy storage to balance the overall power output so that it continues to meet the power request.

In some examples, the controller is arranged (or configured) after a non-fueled cranking operation, to restrict engine power output to below a threshold and to monitor the exhaust oxygen levels to determine when the threshold may be increased and further to complete any additional power demand above the power output available from the engine, using the energy storage. In this way, oxidation of the exhaust aftertreatment due to the =fueled cranking operation can be sidestepped by minimizing the overall emissions from the engine while the aftertreatment deoxidizes again

In some examples, the controller is arranged to restrict engine power output to above a threshold, and further to restrict use of the energy storage to ensure that the minimum engine power delivery is met. This minimum power output will typically be set in real-time depending on the aftertreatment temperature and other conditions such as vehicle speed, wind speed, ambient temperature to ensure that the aftertreatment stays above its effective temperature for emissions reduction. In some examples, the controller is also arranged to monitor the aftertreatment, temperature and to vary the minimum power threshold to keep the aftertreatment temperature above a threshold at which it operates effectively.

Advantageously, the controller is arranged to restrict the rate of change of engine power output to below a threshold and further to complete any additional power demand above the power output available from the engine, using the energy storage. In some examples, the maximum rate of change is a predetermined constant or the maximum rate of change may be based on estimate of aftertreatment oxygen storage capacity. In some examples, the maximum rate of change may be based on power demand and battery power limits (provided in real-time by Battery Management System) so the rate of change does not limit the capability of the system in delivering power for the demand. This taken note of the increased emissions that occur when the engine power is changed rapidly, and this strategy mitigates that increase in emissions.

In some examples, the controller is arranged to monitor the aftertreatment temperature, to inhibit engine stop until the aftertreatment temperature is above a threshold at which it operates effectively. This mitigates a difficulty when an engine Start Stop strategy effectively causes the engine to run with ineffective aftertreatment temperatures because the engine keeps going through it start and cranking cycles.

The controller may also monitor the state of charge of the energy storage to disable this aftertreatment temperature-based engine stop inhibit so that the engine does not keep charging the battery while the state of charge is already higher than an allowed threshold. A scenario when this is more important is when the traction motor is doing regenerative braking and providing power back to battery.

### BRIEF DESCRIPTION OF THE DRAWINGS

Embodiments of the present disclosure will now be described by way of example, with reference to the drawings in which:

FIG. 1 is a schematic block diagram of a hybrid or range extender vehicle architecture;

FIG. 2 is a schematic block diagram of a control system;

FIG. 3 is a set of plots showing engine-out nitrous oxide, tail-pipe nitrous oxide, engine speed, torque command, catalyst temperatures and lambda sensor outputs, against time;

FIG. 4 is a flow chart and plot of cumulative nitrous oxide vs. different selections of engine power for an emissions control strategy;

FIG. 5 is a flow chart and plot of aftertreatment temperature and engine power in a steady state test for an emissions control strategy;

FIG. 6 is a schematic diagram of an emissions control strategy based on limited engine power rate of change;

FIG. 7 is a set of plots showing cumulative tail pipe NOx, aftertreatment temperature, oxygen sensor voltage and engine power, against time;

FIG. 8 is a flow chart of an emissions control strategy based on inhibiting engine stop;

FIG. 9 is a set of plots showing engine speed, fuel flow rate and aftertreatment temperature, against time;

FIG. 10 is a flow chart showing an emissions control strategy based on preventing motoring or engine braking of the engine;

FIG. 11 is a flow chart of an emissions control strategy based on monitoring the temperature of the aftertreatment system;

FIG. 12 is a set of plots showing engine power and aftertreatment temperature, against time; and

FIG. 13 is flowchart showing engine power optimization against aftertreatment states.

### DETAILED DESCRIPTION

The disclosure below, outlines different strategies for operating engines in series hybrid electric vehicles, which have the engine decoupled from the traction system to address emissions problem. Therefore, engine operation has some level of independence from driver request and its operation can be managed for emissions reduction. The disclosure describes features for combustion engines with some features applicable specifically for spark-ignited (SI),

### Strategies:

1. Immediately after engine cranking, the three-way-catalyst (TWC) of a SI engine can be partially or fully oxidized due to the motoring effect. That is, cranking of the engine and rotation of the engine which causes air to pass through the engine and TWC, but without, combustion, e.g. through no fueling, and optionally, no ignition. Once the engine has started, this causes high tail-pipe NOx if the engine is run at high power because the TWC no longer has oxygen storage capacity for NOx reduction. Therefore, in this strategy, the engine is operated at a capped engine power to minimize cumulative NOx until the TWC is back to a good level of oxidation in which it can effectively control NOx emissions. In this scenario, besides engine power as the control lever, other engine control actuation levers can be operated differently from normal operations to minimize tail-pipe NOx, such as varying engine speed and torque independently, spark timing, air fuel ratio, wastegate, variable valve timing/actuation. This strategy is used every time the engine starts, regardless of whether it is a cold or a hot start.

2. For a specific engine, there may be an operating power level Pmin (e.g. part load) below which, in a steady state condition, will result in high tail-pipe emissions because the aftertreatment temperature is not high enough. Therefore, if the aftertreatment temperature is below a threshold, in this strategy, the engine is operated at engine powers higher than Pmin

3. The engine is operated with a capped rate of change of power, in order to reduce emissions due to transient.

4. If the engine is running and the aftertreatment temperature is not high enough, shutting down the engine can result in the next time of the engine restarts becoming a further cold start. One of the reasons is that starting the engine with motoring and cold exhaust flow will cool down aftertreatment. Therefore, if aftertreatment temperature is not higher than a threshold, the engine is inhibited from stopping, except due to some special reasons such as battery state of charge is higher than a threshold while traction motor is doing regenerative braking and keep running engine can result into over-charging battery.

5. The engine is not allowed to be motoring because motoring can cool down aftertreatment. This impacts any type of combustion engine. Specifically for stoichiometric SI engines, motoring the engine will oxidize the TWC and decrease Oxygen Storage Capacity and cause difficulty in managing emissions.

6. An optimal control problem for cold start can be solved based on modeling of emissions and states (typically, temperatures, and/or oxygen storage capacity for TWC) of an aftertreatment system to manage emissions. Look-ahead information can be utilized for optimizing.

The strategies will now be described in more detail.

### Series Hybrid & Engine Operation Overview

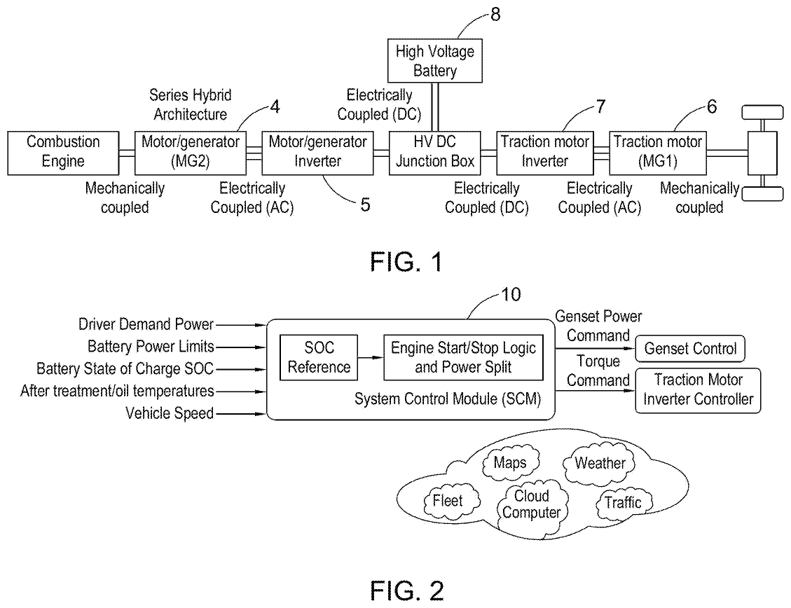

First, some background to series hybrid and range extender architectures is provided. With reference to FIG. 1; the operation of a series hybrid and engine will be described. In the figure, a combustion engine is shown. A genset, including an engine 2 and a motor/generator 4, is mechanically decoupled from a traction motor 6. The genset provides electrical power that can be used by an electrical energy storage such as battery 8 and/or the traction motor 6. Traction motor power can be provided by either the genset alone, the battery alone, or a combination of both.

With reference also to FIG. 2, a System Control Module (SCM)—controller 10 makes engine start/stop decisions and engine/genset power commands from its power split strategy to command the engine 2 and motor/generator (MG2) 4. The controller 10 may be implemented as one or more computers or other processors, and the disclosed embodiments may be embodied as a computer readable storage medium (or multiple computer readable media) encoded with one or more programs or executable instructions that, when executed on or by one or more computers or other processors, perform methods or processes that implement the various embodiments of the disclosure discussed herein. A computer readable storage medium may retain information for a sufficient time to provide computer-executable instructions in a non-transitory form (non-transitory, computer-readable medium).

Typically, the motor generator 4 is an AC device and the traction motor also is an AC device although this is not necessarily the case in either the respect. In the example shown in FIG. 1, it will be noted that these are both AC devices and the battery 8 is typically a DC device. Thus inverters 5 and 7 perform conversion between DC and AC.

In a series or range extender architecture, the engine is not mechanically coupled to the driven wheels and because the battery 8 can provide power to the traction motor 6, the engine 2 operation has some independence from any traction motor/vehicle power request. Thus, the engine operation can be optimized for fuel economy and emissions while the overall system still provides acceptable torque delivery in response to power requests.

Feature 1: Three-Way Catalyst Oxidation State-Based Engine Operation after Engine Cranking

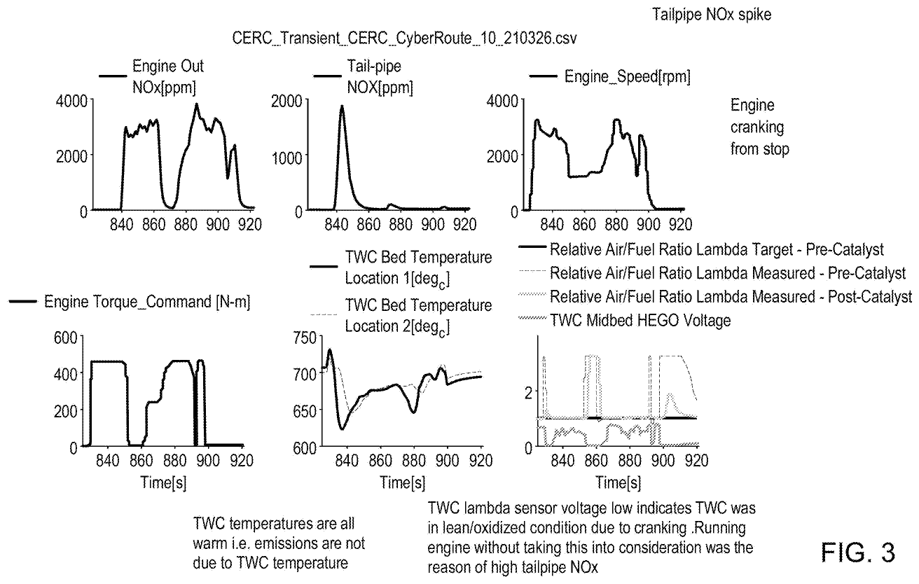

With reference to FIG. 3, the plot shows the effect of the engine firing after engine cranking from stop, even though the TWC temperatures were all warm.

The charts from left to right, top to bottom, respectively show instantaneous engine out NOx, instantaneous tail pipe NOx, engine speed, engine torque demand. TWC temperatures, and inlet, mid-bed, and outlet lambda sensor data.

The effect is a tailpipe NOx spike, which is very visible at about 850 seconds. This is due to the TWC being oxidized after engine cranking (only air, no fuel) and the engine then being run without taking this into account. Thus NOx output increases significantly because the TWC is unable to control the NOx until it, is deoxidized which then provides the tail end of the spike, as the NOx comes back under control at about 860 seconds. The plot showing Lambda sensor output shows the lean condition during cranking because the engine is being cranked without fueling, which consequently oxidizes the TWC before engine starts firing. This can be seen at about 830 seconds. The chart showing TWC temperatures also shows that there is a cooling effect during cranking at about 840 seconds during cranking as air passes through the TWC, but nevertheless the TWC is still mostly above 650C i.e. very warm. Thus the NOx spike is not concerned with TWC temperature, but rather the oxidation effect.

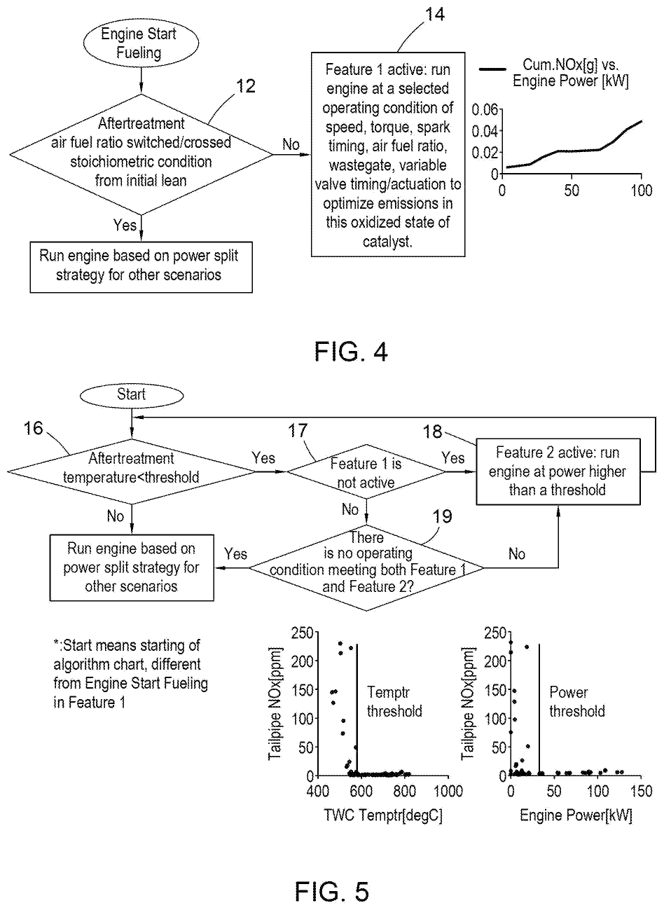

FIG. 4 shows an algorithm for minimizing this NOx spike and consequent test data. The algorithm operates as a loop with a decision box 12 which monitors the aftertreatment air fuel ratio and in essence determines when the TWC has sufficiently deoxidized to be adequately functional again after cranking. The decision is based around the air fuel ratio measured using one or more lambda sensors crossing the stoichiometric condition from the initial lean at cranking/startup. The loop contains a mode 14 in which engine can be operated differently in this scenario by utilizing different actuation levers, for example engine speed, torque, spark timing, air fuel ratio, turbo waste gate operation, supercharger bypass valve operation, and/or variable valve timing/actuation to minimize cumulative emissions until TWC has sufficiently deoxidized i.e. its Oxygen Storage Capacity is at a good level. A specific strategy of the mode 14 is simply capping engine power while still running engine at a torque-speed curve, and similarly for other actuation levers, as nominal operation with series hybrid architecture. The torque-speed curve of engine operation in series hybrid architecture is widely known as optimal operation line.

A series of tests on an engine were performed each running at different powers after the TWC was fully oxidized, until TWC oxidation was reduced. The plot on the right of FIG. 4 shows that running with a capped engine power during TWC deoxidization minimized cumulative NOx and can be used as the operating condition when Feature 1 is active. More control actuation levers can be used to optimize, not only single variable as engine power as abovementioned. This feature is achievable thanks to the series hybrid arrangement and the consequent decoupling between engine and traction demand. In this particular system the traction motor 6 can fill in any shortfall in overall torque using energy stored in the battery 8, while the TWC is deoxidized.

The engine power cap threshold is established by prior calibration and stored as a map or just a constant of power, instead of a map, in the system control module. Other potential control levers are mentioned above.

### Feature 2: Aftertreatment Temperature-Based Lower Limit Engine Power

With reference to FIG. 5, The plot of steady state testing data shows that if the engine power remains below a threshold, the TWC is not capable of converting all engine emissions. This is because below that power, the TWC temperature is below its threshold of fully capable of conversion.

Thus, Feature 2 limits engine power to be always higher than a threshold if TWC temperature is not high enough. This is to avoid running engine at powers that can cool down the TWC to be below the threshold of fully capable of emissions conversion abovementioned.

Thus, FIG. 5 shows an algorithm for ensuring that the TWC remains above an effective temperature. In step 16, a decision is made about whether the TWC temperature is below a threshold, and this is also linked to whether feature 1 is inactive. If the aftertreatment temperature is less than a threshold at which the TWC can function effectively, and Feature 1 is not active, then (step 18) the engine is operated at a power higher than a threshold to ensure that the TWC remains effective due to its temperature. If the aftertreatment temperature is less than a threshold at which the TWC can function effectively and Feature 1 is active, then Feature 1 has higher priority than Feature 2. Namely, if the engine has no engine operating condition satisfying both Feature 1 and Feature 2 then only Feature 1 is active (step 19 branched with Yes); otherwise, both Feature 1 and Feature 2 are active (step 19 branched with No). An example of there is no operating condition satisfying both Feature 1 and Feature 2 is the specific strategy of mode 14 (Feature 1) of capping engine power and the capped engine power is lower than the threshold in step 18 (Feature 2). In this scenario, the capped (max) engine power of Feature 1 is chosen, although it does not satisfy Feature 2.

Looking in more detail at the plots, it can be seen that at a power threshold below approximately 40 kW, in the test example, the TWC temperature remains below 580 degrees centigrade. At temperatures below 580 degrees centigrade, the NOx emitted from the tailpipe rises rapidly. This illustrates that there is a nonlinear relationship between minimum engine power and NOx emissions, and that below a minimum engine power, NOx emissions rise very rapidly.

### Feature 3: Transient Limit Engine Operation

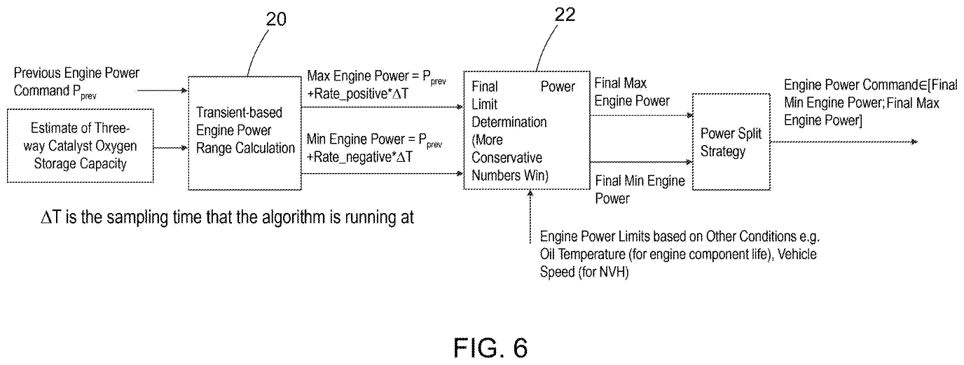

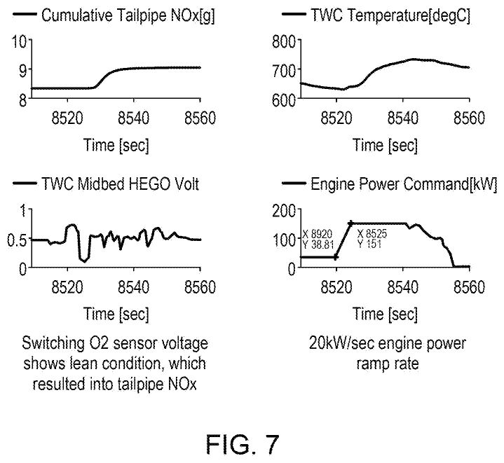

With reference to FIGS. 6 and 7, the plot (FIG. 7) from testing data illustrates the impact of transient engine power outputs to emissions.

Even with a well calibrated air to fuel ratio for an (Federal Test Procedure, commonly known as FTP-75 Coma which is a transient duty cycle) FTP cycle with, running the engine for a hybrid application with a different engine cycle may result in transient high NOx emissions (oxygen sensor voltage also shows lean) although the engine ramp rate is already quite slow, for example, 20 kW/sec. A transient limit strategy thus reduces transient emissions.

Feature 3 reduces the level of transient to a level to minimize tailpipe emissions. This is implemented by calculating min and max engine powers allowed in a power split strategy based on the previous engine power and also allowed rates. The rate can be a conservative constant or based on estimate of TWC Oxygen Storage Capacity. The estimate of TWC Oxygen Storage Capacity can be based on one or more oxygen sensors installed at one or more locations on the TWC and, according to some examples, in combination with an equation-based model of TWC.

With reference particularly to FIG. 6, the algorithm shows a step 20 of considering a transient engine power range calculation based on the previous engine power (Pprev) and also an estimate of the three way catalyst oxygen storage capacity. The step 20 provides a maximum engine power which is the maximum rate of change relative to the previous engine power. It also provides a minimum engine power which is the minimum engine power, which is the maximum rate of negative change relative to the previous engine power.

The step 20 is then fed into the step 21 in addition to engine power limits based on other conditions, such as oil temperature which is related to engine component life, how long from engine cranking which is also related to engine component life, vehicle speed which is related to noise, vibration, and, harshness (NVH). The engine power limits for how long from engine cranking is due to the fact that the engine may need some time to allow lubricant to circulate to bearings, turbo, etc. Running at high engine power when lubricant is not well-distributed may result into engine component life reduction.

The step 21 is then able to inform a power split strategy 22, which has the boundaries of maximum and minimum engine power as inputs and is then able to generate an engine power command which remains within those boundaries.

In one embodiment, the Rate_positive and Rate_negative can change in real-time, based on the condition of TWC Oxygen Storage Capacity to maintain the oxidization state of the TWC in a good range. In another embodiment, the Rate_positive and Rate_negative are constant and are conservative enough so that transient emissions are always within the target.

For a series hybrid architecture with the following algebraic equation in electrical power domain, Traction Power is equal to Engine_Power+Battery_Power where Battery_Power should be within the recommended limits provided by Battery Management System (BMS) in real-time. Therefore, depending on system design and operating scenario, limiting engine power further for transient emissions minimization can result in changing the capability of the traction system in meeting traction power demand. In one embodiment, Rate_positive and Rate_negative are not the only for limits for transient emissions but also for not changing the capability of the traction system in meeting traction power demand. In other words, the magnitudes of Rate_positive and Rate_negative are greater than real-time thresholds so that in comparison with the case of rate limits not being applied, the Max Engine Power and MM Engine Power do not result in Traction Power being away further from the traction power target, given real-time values of minimum and maximum battery power. In another embodiment, Rate_positive and Rate_negative are only for limits for transient emissions regardless of the impact on changing the capability of the traction system in meeting traction power demand.

With particular reference to FIG. 7, it will be seen that a transient power ramp at 8520 seconds caused a cumulative NOx increase at about 8530 seconds. Because the TWC temperature indicates the TWC is already warmed up, NOx was emitted due to the transient operation. A slower rate of change of engine power would have emitted less NOx.

### Feature 4: Aftertreatment Temperature-Based Engine Stop Inhibit

Feature 4 helps to avoid a situation in which the engine is in the process of warming up, in particular the TWC is being warmed up, but a hybrid strategy decides to shut-down the engine because of other factors, such as battery state of charge while the aftertreatment is under temperature, and/or while performing some aftertreatment thermal management, such as spark timing retard. This may lead to the engine having multiple cold starts when it restarts again later, which thus increases emissions. This feature takes into account the aftertreatment temperature and the condition of SOC upper limit, and Feature 4 inhibits engine stop unless the aftertreatment temperature and state of charge parameters are suitable. An example for clarification is: if the battery is not allowed to be fully charged (SOC of 100%) and the powertrain does not consume any energy because the traction motor is doing regenerative braking to provide just enough power for vehicle accessories, if engine stop inhibit is activated, the engine energy will have to go to battery and overcharge the battery. The limits from battery can be SOC, or limits in battery power that battery allows.

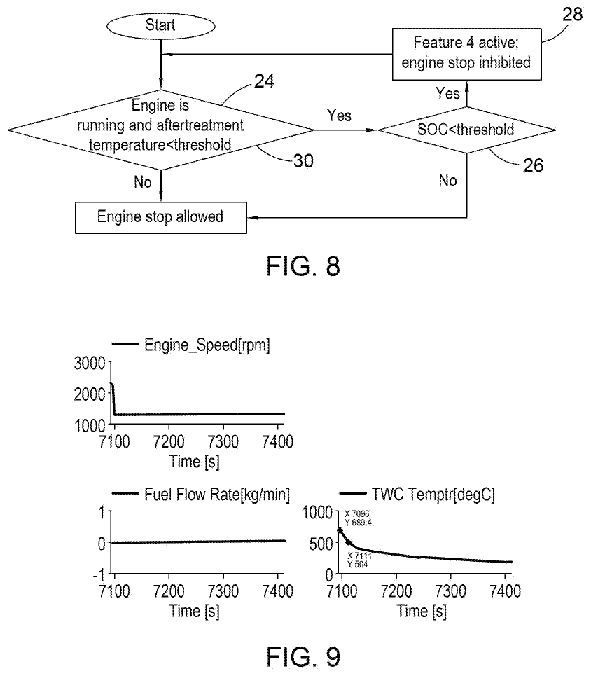

With reference to FIG. 8, it will be seen that to implement this feature, after engine start, a decision 24 determines whether the engine is running and whether the aftertreatment TWC temperature is below a threshold at which it can effectively control NOx. If the aftertreatment temperature is not sufficiently high, then decision box 26 is considered, which looks at whether the state of charge of the battery is below a predetermined threshold. If it is, then engine stop is inhibited in step 28 and the loop is continued. If the aftertreatment temperature is not below predetermined threshold, or the state of charge is not below a predetermined threshold, then in step 30, an engine stop is allowed.

### Feature 5: Engine Motoring Disallowed

With reference to the plots of FIG. 9, engine motoring has at least two negative impacts:
(i) cooling the aftertreatment very fast as in the testing data plot (see the rapid decline to the knee in the temperature plot of FIG. 9 at approximately 7130 seconds and the subsequent temperature decline); and
(ii) for stoichiometric SI engines, it oxidizes the TWC in the same way as illustrated in Feature 1 with engine cranking (zero fueling).

Note that this motoring is significantly longer than cranking, thus having more negative impact in terms of both oxidizing TWC and cooling aftertreatment.

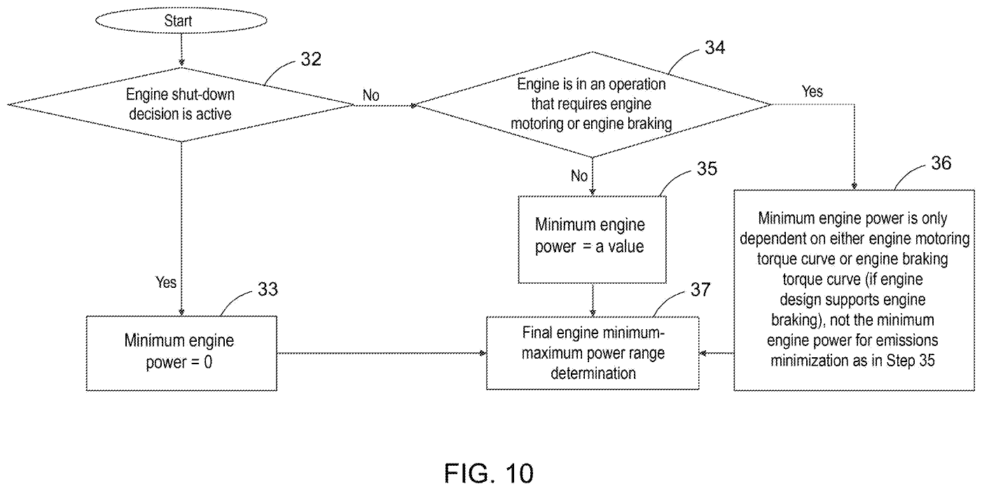

Thus feature 5 inhibits engine power below a threshold, except if a start/stop logic decides to shut down engine. This engine power threshold is determined based on an engine performance below which the engine has to motor (i.e. fueling is inhibited) due to poor combustion if the engine is firing. This is shown in FIG. 10. At decision box 32, it is determined whether engine Start Stop logic has decided to stop the engine. If that is the case then the minimum engine power is allowed to go to zero and the engine is stopped. In this condition, air is not being passed through the aftertreatment, so that it is not being exceptionally cooled, and furthermore the aftertreatment is not, being oxidized by the passage of air. If the engine shutdown decision is not active, then in step 34, the engine is checked if its operation requires engine motoring or engine braking. For step 34, an operation that requires engine motoring or engine braking can be (i) when battery contactors opened during failure mode and the genset is in voltage control mode to regulate DC bus voltage. In this operation, the engine is required to be able to operate in a negative torque region for voltage control capability (ii) engine is used to provide an additional energy dissipation mechanism for traction motor regenerative braking in addition to battery charging from regeneration. If the engine is not in motoring or braking mode, then in step 35, a minimum engine power is assigned. If the engine is in motoring or braking mode, then in step 36, minimum engine power is only dependent on either engine motoring torque curve or engine braking torque curve (if engine design supports engine braking), not the minimum engine power for emissions minimization as in step 35. In step 37, the minimum power is assigned, in conjunction with the maximum power from other features described here, thus establishing a power range for engine operation when the engine is running i.e. when it is not shut down.

### Feature 6: Optimal Emissions Control for Cold Start

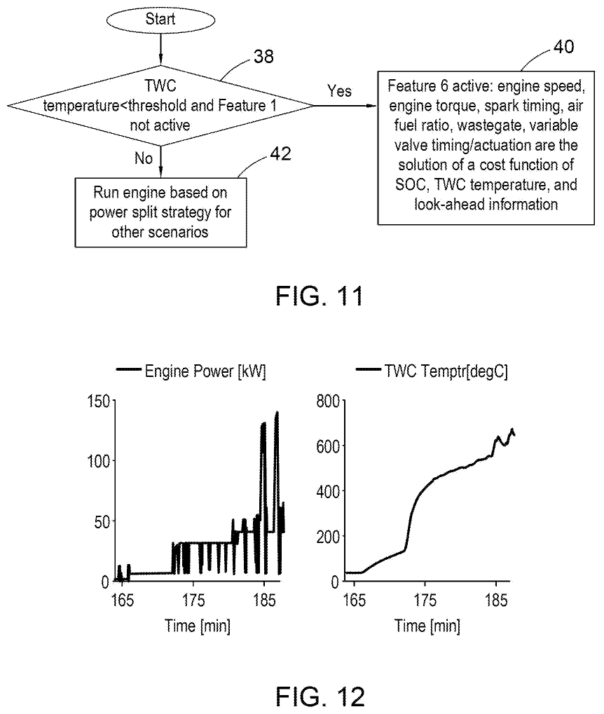

Feature 6 is concerned with optimizing the cold start condition until the aftertreatment has sufficiently warmed to be effective. A simplified result of Feature 6 is shown in the simulation plot of FIG. 12. In this case, engine power is the single control variable, which can be made more optimal by using multiple control parameters as in the algorithm flowchart of FIG. 11. Thus with reference to FIG. 11, at step 38, a decision is made to determine whether the aftertreatment temperature is below its effective threshold and whether feature one is inactive. If both these conditions are met then in step 40, the engine is operated according to the solution of a cost, function with the states of SOC and one or more aftertreatment temperatures and look ahead information. In this scheme, the problem can be formulated as an optimal control problem, such as utilizing Model Predictive Control. The cost function may be a weighted summation of cumulative fuel consumption and cumulative tail-pipe emissions while maintaining SOC reference tracking and warming up aftertreatment temperatures. The look ahead information may be a continuous variable indicating the load power demand which is predicted at a point in the future which is sufficiently far ahead. Alternatively, a range of predictions could be provided, and/or prediction over a finite time window in the future (the horizon) could be provided. The prediction vector over the horizon may be a vector versus time or a vector versus traveled distance. The results of this can be seen in the right side plot of FIG. 12, i.e. that the controller has different levels of engine powerbetween cold aftertreatment temperature and warm aftertreatment temperature.

If at step 38 either feature one is active or the TWC temperature is below its effective threshold, then the engine can be run as normal based on power split strategies as required. This is shown in step 42.

The optimal engine power profile is lower at lower aftertreatment temperature to minimize tailpipe emissions and then when TWC temperature achieves a warm condition, engine power can become higher as emissions are no longer impacting cost function. Thus with reference to FIG. 12, it will be seen that the engine power is limited until about 185 minutes at which point the strategy/controller automatically chooses to run at higher powers because the aftertreatment has reached a sufficient temperature to be effective. In the period from about 168 to 185 minutes, the power is controlled which helps to warm the aftertreatment, whilst not emitting significant NOx. Depending on the level of complexity of the strategy implementation in real-world applications, a more simple implementation can be obtained. For example, engine power before aftertreatment reaching the effective temperature, engine power does not have to be a time-varying profile based on optimal control solution but can be a map stored in a vehicle computer. The map may be calibrated to minimize cumulative tail-pipe emissions from engine start till engine reached the effective temperature. The map can be obtained from testing and dependent on ambient temperature, vehicle speed, and/or wind speed, which impacts the heat rejection process of aftertreatment temperature to ambient. Alternatively, the map may be a single constant applied across all conditions. This may be applied to spark ignition and compression ignition engines.

The skilled person will appreciate that these strategies may be used independently or in any combination with generally greater improvement in exhaust emissions occurring as more of the strategies are used.

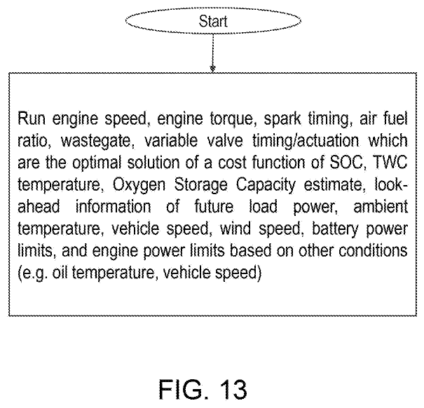

In a more general embodiment, Feature 1, Feature 2, Feature 3, and Feature 6 can be integrated as a single optimal control problem with the states of SOC, TWC temperature and Oxygen Storage Capacity. In this case, Oxygen Storage Capacity estimate is an indicator if aftertreatment air fuel ratio switched/crossed stoichiometric condition from initial lean as in FIG. 4 of Feature 1. The strategy takes into account TWC temperature to determine engine power, thus performing the functionality of Feature 2 illustrated in FIG. 4. The strategy takes into account Oxygen Storage Capacity, thus performing the functionality of Feature 3 as illustrated in FIG. 6. The strategy is formulated as a more generalized version of the optimal control problem described, thus covering Feature 6 as illustrated in FIG. 11. This general embodiment is more complex in implementation but can be illustrated with a more simple flow chart as in FIG. 13.

What is claimed is:

1. A series or range extender hybrid vehicle drive system comprising:
a combustion engine with an exhaust aftertreatment device;
an electrical energy storage;
a motor/generator mechanically coupled to the engine, electrically coupled to the energy storage, and operable to generate electrical energy when driven by the engine;
a traction motor, wherein the traction motor is mechanically couplable to the driven wheels of a vehicle, and wherein the system is operable to drive the traction motor using power from the energy storage, power from the engine, or a combination of power from the engine and the energy storage; and
a controller operable to:
receive input data representative of a requested power from the system, an indication of a state of charge of the energy storage and at least one of an oxygen level in an exhaust gas from the engine or a temperature in the exhaust gas, and
provide output signals to control torque and speed of the engine and the motor/generator to minimize an exhaust emissions output and any tracking error of the state of charge of the energy storage to a desired target.

2. The system of claim 1, wherein the controller is configured after a non-fueled cranking operation, to restrict an engine power output to below a threshold and to monitor the oxygen level in the exhaust gas to determine when the threshold may be increased and further to complete any additional power demand above the engine power output that is available from the engine using the energy storage.

3. The system of claim 1, wherein the controller is configured to restrict an engine power output to above a threshold, and further to restrict use of the energy storage to ensure that a minimum engine power delivery is met.

4. The system of claim 1, wherein the controller is configured to monitor an aftertreatment temperature and to vary a minimum power threshold to keep the aftertreatment temperature above a threshold at which the aftertreatment device operates effectively.

5. The system of claim 1, wherein the controller is configured to restrict at least one of a positive rate of change or a negative rate of change of an engine power output to below a threshold and further to complete any additional power demand above the engine power output that is available from the engine using the energy storage.

6. The system of claim 5, wherein at least one of the positive rate of change or the negative rate of change is restricted based on a maximum rate of change, and the maximum rate of change is a predetermined constant.

7. The system of claim 5, wherein at least one of the positive rate of change or the negative rate of change is restricted based on a maximum rate of change, and the maximum rate of change is based on an estimate of an aftertreatment oxygen storage capacity.

8. The system of claim 1, wherein the controller is configured to monitor an aftertreatment temperature, to inhibit engine stop until the aftertreatment temperature is above a threshold at which the aftertreatment device operates effectively if the energy storage and load power demand conditions allow to do so without exceeding limits of the energy storage and to ensure that the overall power delivered by the system does not exceed the requested power.

9. The system of claim 1, wherein the controller is configured to restrict engine power output to above a threshold at which engine does not perform engine motoring or engine braking and further to restrict use of the energy storage to ensure that a minimum engine power delivery is met in the operations that the engine motoring or the engine braking is not required.

10. A controller for a series or range extender hybrid vehicle having a combustion engine with an exhaust aftertreatment device, a motor/generator, an electrical energy storage, and a traction motor, wherein the traction motor is mechanically couplable to the driven wheels of a vehicle, the motor/generator is mechanically coupled to the engine, the motor/generator is electrically coupled to the energy storage, the motor/generator is operable to generate electrical energy when driven by the engine, and the system is operable to drive the traction motor using power from the energy storage, power from the engine, or a combination of power from the engine and the energy storage, wherein the controller is operable to:
receive input data representative of a requested power from the system, an indication of a state of charge of the energy storage and at least one of an oxygen level in exhaust gas from the engine and temperature in the exhaust gas; and
provide output signals to control torque and speed of the engine and the motor/generator to minimize an exhaust emissions output and any tracking error of the state of charge of the energy storage to a desired target.

11. The controller of claim 10, wherein the controller is configured after a non-fueled cranking operation, to restrict an engine power output to below a threshold and to monitor the oxygen level in the exhaust gas to determine when the threshold may be increased and further to complete any additional power demand above the engine power output that is available from the engine using the energy storage.

12. The controller of claim 10, wherein the controller is configured to restrict an engine power output to above a threshold, and further to restrict use of the energy storage to ensure that a minimum engine power delivery is met.

13. The controller of claim 10, wherein the controller is configured to monitor an aftertreatment temperature and to vary a minimum power threshold to keep the aftertreatment temperature above a threshold at which the aftertreatment device operates effectively.

14. The controller of claim 10, wherein the controller is configured to restrict at least one of a positive rate of change or a negative rate of change of an engine power output to below a threshold and further to complete any additional power demand above the engine power output that is available from the engine, using the energy storage.

15. The controller of claim 14, wherein at least one of the positive rate of change or the negative rate of change is restricted based on a maximum rate of change, and the maximum rate of change is a predetermined constant.

16. The controller of claim 14, wherein at least one of the positive rate of change or the negative rate of change is restricted based on a maximum rate of change, and the maximum rate of change is based on an estimate of an aftertreatment oxygens storage capacity.

17. The controller of claim 10, wherein the controller is configured to monitor an aftertreatment temperature, to inhibit engine stop until the aftertreatment temperature is above a threshold at which the aftertreatment device operates effectively if the energy storage and load power demand conditions allow to do so without exceeding limits of the energy storage and to ensure that the overall power delivered by the system does not exceed the requested power.

18. The controller of claim 10, wherein the controller is configured to restrict engine power output to above a threshold at which engine does not perform engine motoring or engine braking and further to restrict use of the energy storage to ensure that a minimum engine power delivery is met in the operations that the engine motoring or the engine braking is not required.

19. A non-transitory, computer-readable medium, storing instructions that, when executed by a computerized controller for a series or range extender hybrid vehicle having a combustion engine with an exhaust aftertreatment device, a motor/generator, an electrical energy storage and a traction motor, wherein the traction motor is mechanically couplable to the driven wheels of a vehicle, the motor/generator is mechanically coupled to the combustion engine, the motor/generator is electrically coupled to the energy storage, the motor/generator is operable to generate electrical energy when driven by the combustion engine, and the system is operable to drive the traction motor using power from the energy storage, power from the engine, or a combination of power from the engine and the energy storage, cause the computerized controller to:
receive input data representative of a requested power from the system, an indication of a state of charge of the energy storage and at least one of an oxygen level in an exhaust gas from the engine or a temperature in the exhaust gas, and
provide output signals to control torque and speed of the engine and the motor/generator to minimize an exhaust emissions output and any tracking error of the state of charge of the energy storage to a desired target.
